(19) United States
(12) Patent Application Publication
(10) Pub. No.: US 2010/0288853 A1
(43) Pub. Date: Nov. 18, 2010

(54) Spraying Device

(76) Inventor: Bennett Kennedy, Oakboro, NC (US)

Correspondence Address: Clements Bernard PLLC, 1901 Roxborough Road, Suite 250, Charlotte, NC, 28211, US

(21) Appl. No.: 12/761,790

(22) Filed: Apr. 16, 2010

Related U.S. Application Data
(60) Provisional application No. 61/178,109, filed on May 14, 2009.

(51) Int. Cl. B05B 15/00

(52) U.S. Cl. 239/337; 239/375

(57) ABSTRACT

A spraying device that includes a handle having a hollow inner cavity and a body that has an interior void for receiving a container containing liquid. A pump is disposed within the interior void of the body, and a motor is disposed within the interior void of the body for operating the pump. A spray nozzle for dispensing the liquid contained within the container is disposed on the exterior of the body. The spraying device optionally includes a hood over the spray nozzle for limiting over spray.

### CROSS REFERENCE TO RELATED PATENT APPLICATION

The current application claims the benefit of the earlier priority filing date of the provisional application, Ser. No. 61/178,109, that was filed on May 14, 2009.

### FIELD OF THE INVENTION

The present invention relates generally to a spraying device and more generally relates to a herbicide spraying device that concentrates the spray of herbicide on the desired plant or weed, resulting in a concentrated spray area and the use of less herbicide than with a commonly utilized spraying device.

### BACKGROUND OF THE INVENTION

Sprayers have been used for many years to deliver herbicide to a plant or a weed. These sprayers are able to spray large swatches of plants or weeds in order to coat them with the herbicide. Unfortunately, these spraying devices spray large amounts of herbicide that go unused, or worse, contact plants or grasses that are not intended to be sprayed. These spraying devices waste large amounts of herbicides, resulting in an increase in the amount of herbicide that need to be purchased. On the other hand, a herbicide may only be intended for spraying an intended weed, but because of the total inaccuracy of the spraying device, an expensive plant is unintentionally coated with the herbicide, resulting in the death of the plant.

The spraying device disclosed in the present invention allows the spray of the herbicide to be concentrated.

### BRIEF SUMMARY OF THE INVENTION

One embodiment of the present invention includes a handle and a body having an interior void for receiving a container containing liquid. A pump is disposed within the interior void of the right shell and the left shell. A motor is disposed within the interior void of the right shell and the left shell for operating the pump, and a spray nozzle for dispensing the liquid contained within the container.

According to another embodiment of the present invention, a spraying device that includes a switch for activating and deactivating the motor.

According to yet another embodiment of the present invention, a spraying device that includes a hood positioned around the spray nozzle.

According to yet another embodiment of the present invention, a spraying device that includes a handle having a hollow inner cavity and at least one battery positioned within the hollow inner cavity of the handle.

According to yet another embodiment of the present invention, a spraying device that includes a container mount having inner threads for receiving a correspondingly threaded container and engaging the container mount and the container in a releasably engaged arrangement, wherein the container mount further includes a gasket disposed between the container and container mount.

According to yet another embodiment of the present invention, a spraying device that includes a spray nozzle that is angled.

According to yet another embodiment of the present invention, a spraying device that includes a spray tube engaged to the pump for transporting the liquid to the spray nozzle.

According to yet another embodiment of the present invention, a spraying device that includes a handle having a hollow inner cavity, and a body comprising a right shell and a left shell that are releasably engaged to each other forming an interior void for receiving a container containing liquid. A pump is disposed within the interior void of the right shell and the left shell. A motor is disposed within the interior void of the right shell and the left shell for operating the pump. A power source is positioned within the hollow inner cavity of the handle for supplying power to the motor. A switch is disposed on the handle for activating and deactivating the supply of power to the motor, and a spray nozzle for dispensing the liquid contained within the container.

According to yet another embodiment of the present invention, a spraying device that includes a switch that is engaged to an electrical wire and the electrical wire is engaged to the power source.

According to yet another embodiment of the present invention, a spraying device that includes a handle having a hollow inner cavity, and a body comprising a right shell and a left shell that are releasably engaged to each other forming an interior void. A container mount is disposed within the interior void for receiving a container of liquid that comprises a gasket and an aspirator valve, wherein the gasket prevents leakage from the container when engaged to the container mount and the aspirator valve permits air to pass into the container. A pump is disposed within the interior void of the right shell and the left shell. A motor is disposed within the interior void of the right shell and the left shell for operating the pump, and at least one battery positioned within the hollow inner cavity of the handle for supplying power to the motor. A switch is disposed on the handle for activating and deactivating the supply of power to the motor. A spray nozzle for dispensing the liquid is contained within the container.

### BRIEF DESCRIPTION OF THE DRAWINGS

The present invention is illustrated and described herein with reference to the various drawings, in which like reference numbers denote like system components, respectively, and in which:

FIG. 1 is a perspective view of the spraying device;

FIG. 2 is an exploded view of the spraying device of FIG. 1;

FIG. 3 is a cross-sectional view of the spraying device of FIG. 1;

FIG. 4 is a perspective view of the spraying device in use;

FIG. 5 is an exploded view of the electrical parts of the spraying device;

FIG. 6 is a perspective view of the liquid handling parts of the spraying device;

FIG. 7 is a cross-sectional view of the check valves of the spraying device;

FIG. 8 is another embodiment of the spraying device.

### DETAILED DESCRIPTION OF THE INVENTION

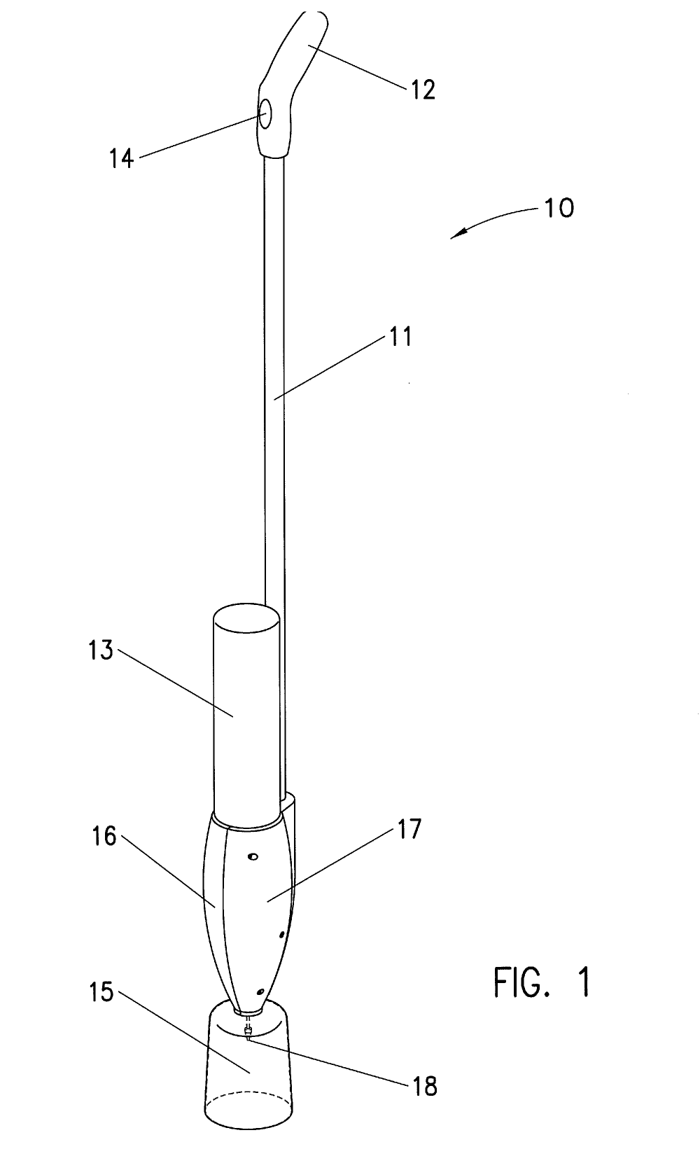

Referring now specifically to the drawings, an exemplary sprayer is illustrated in FIG. 1 and is shown generally at reference numeral 10. The sprayer 10 includes a handle 11, a handle grip 12, hood 15 with a spray nozzle 18 positioned inside, and a body comprising a right shell 16 and a left shell 17. The hood 15 is held between the right shell 16 and a left shell 17 forming an interior void therein. A container 13 is positioned within the right shell 16 and left shell 17. A handle 11 is fastened onto the right shell 16 and left shell 17 and is provided with a handle grip 12 on its upper end. The handle grip 12 is equipped with a switch 14 to activate the sprayer 10.

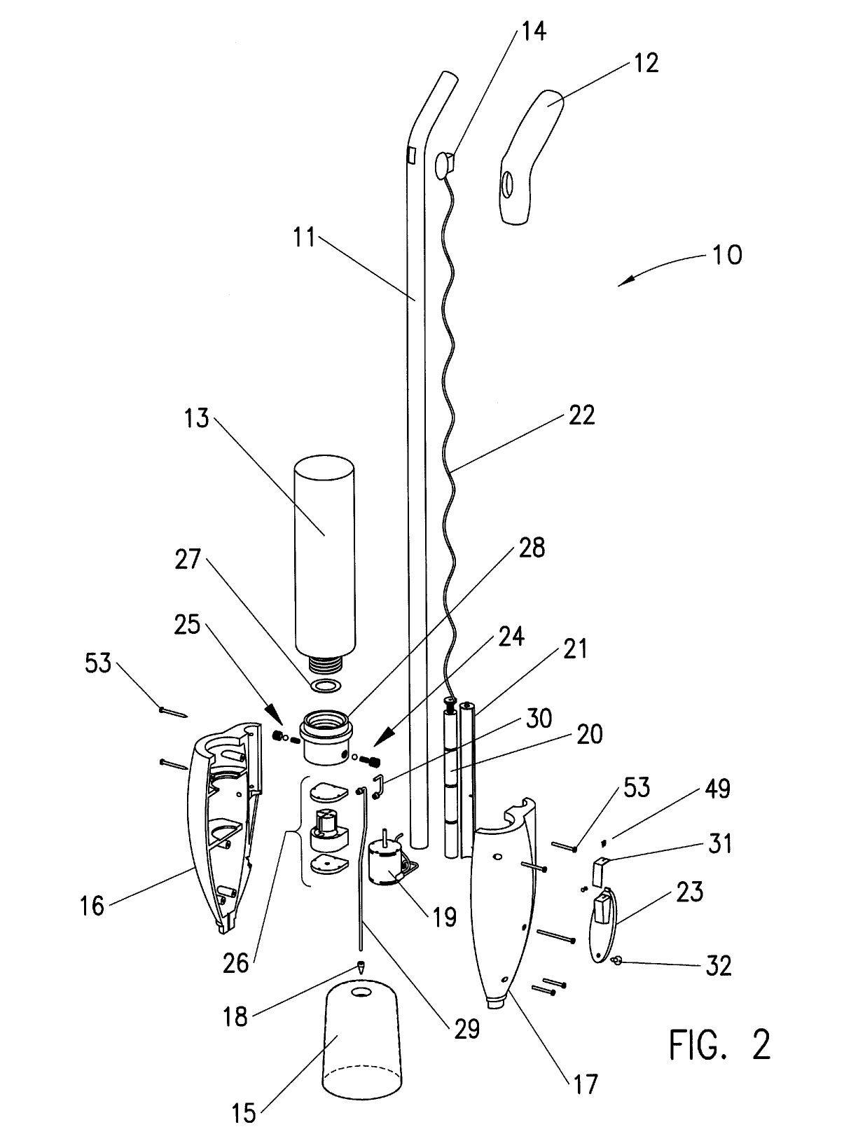

As illustrated in FIG. 2, the hood 15 on the bottom portion of the sprayer 10 serves to protect neighboring plants from potentially harmful over spray. It is preferably made from a transparent material, such as plastic or the like. The spray nozzle is 18 positioned within the hood 15 and is mounted on a spray tube 29 which in turn is mounted on the exit side of a pump 26. The pump 26 is a conventional vane type pump driven by an electric, low voltage motor 19. The motor 19 is engaged to the pump 26 which in turn is attached to a container mount 28. The container 13 is screwed into the container mount 28 with a gasket 27 between them for sealing purposes. The neck of the container 13 is threaded and the inner portion of the container mount 28 contains a correspondingly threaded portion. The container 13 and container mount 28 are releasably connected by the corresponding threaded portions. The container mount 28 contains an aspirator valve 24 for allowing air to pass into the container 13 in order to make up the space evacuated by the spent liquid. A sealing valve 25 in the container mount 28 prevents the liquid from leaking through the pump 26 when the unit is not in use. The connector tube 30 joins the container mount 28 and the pump 26 hydraulically. The container mount 28, the pump 26, and motor 19 are enclosed by the right shell 16 and the left shell 17. The right shell 16 and left shell 17 are held together by several typical screw fasteners 53.

The handle 11 contains a hollow inner cavity for storing a power source. As illustrated herein, the power source consists of at least one battery 20, but preferably more than one battery 20, and more preferably at least four “C” or “D” batteries 20 arranged in series to supply the necessary power. The bottom of the lowest battery 20 makes electrical contact with the contact strip 31 when the battery lid 23 is closed and held by the closing screw 32. The contact strip 31 is fastened to the battery lid 23 with strap screws 49. The contact strip 31 in turn is electrically connected to the motor 19. The upper end of the up most battery 20 is connected by a wire 22 with the switch 14 in the handle grip 12. Depressing the switch 14 will connect one side of the battery 20 to the conductive handle 11 which in turn is electrically connected to the motor 19 and starts the motor 19 and the pump 26 for the spraying cycle.

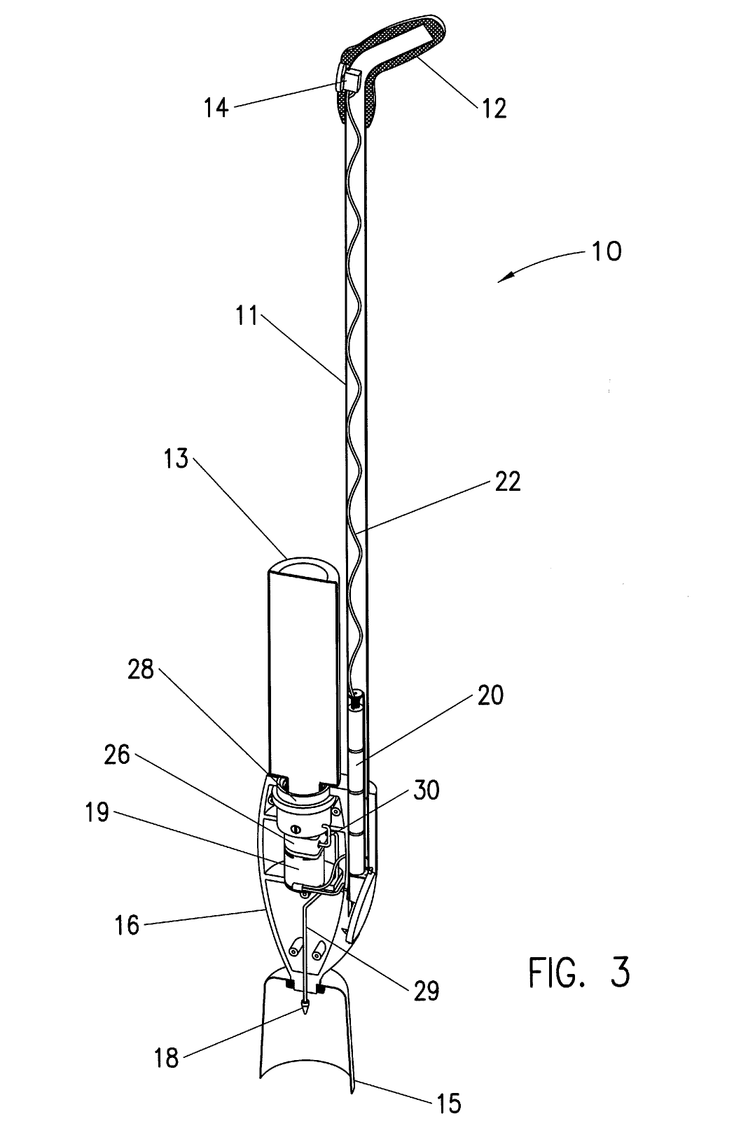

As illustrated in FIG. 3, the spray nozzle 18 is positioned inside the hood 15. It is hydraulically connected through the spray tube 29 with the exit side of the pump 26. The input side of the pump 26 is hydraulically connected to the container mount 28 by the connector tube 30 for receiving the liquid from the container 13. The pump 26 is mechanically coupled with the motor 19. The batteries 20 are positioned within a hollow inner cavity of the handle 11 of the sprayer 10 and provide the necessary power to the motor 19. The batteries 20 are electrically connected through the wire 22 with the switch 14 in the handle grip 12. In an alternative embodiment, the batteries may be rechargeable.

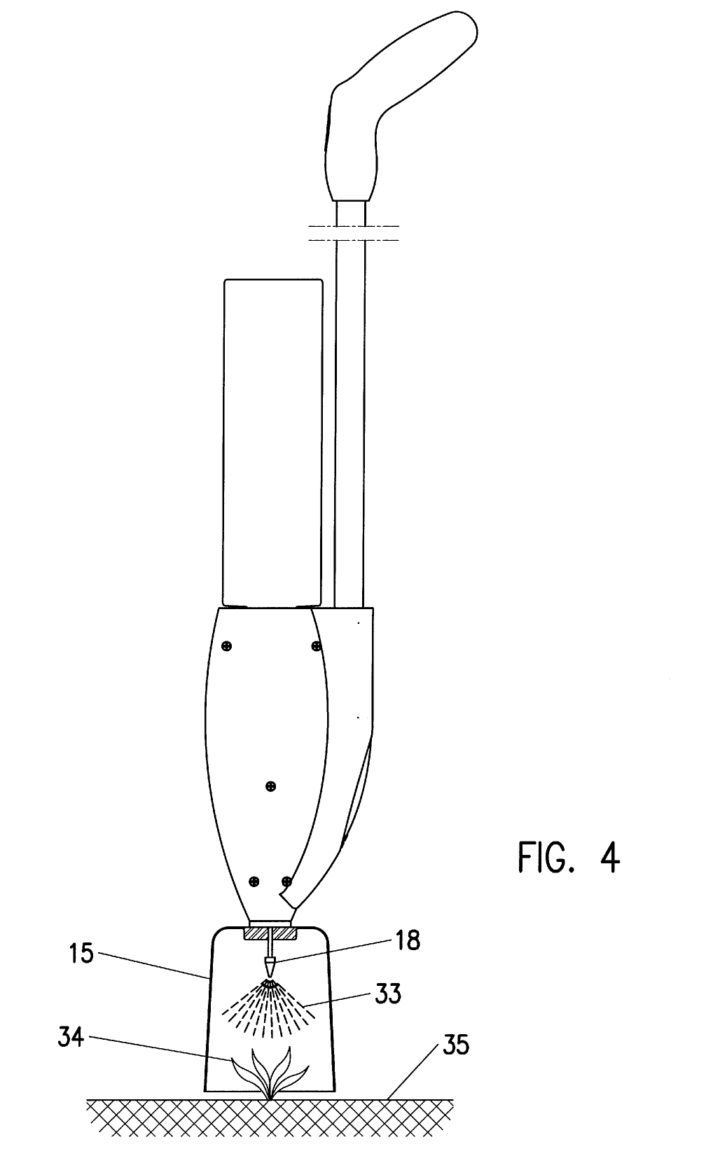

As illustrated in FIG. 4, the spray nozzle 18 is positioned inside the hood 15. The hood 15 is designed to be positioned over a plant or weed prior to depressing the switch 14, causing the liquid in the container 13 to disperse. Once the hood 15 is placed over the plant or weed, the switch 14 is depressed and the liquid contained in the container 13 is dispensed onto the plant or weed through the spray nozzle 18. The hood 15 shields the spray against the outside in order to protect other plants. This hood 15 also economizes the usage of the sprayed liquid since all dispersed liquids are contained within the inside of the hood 15.

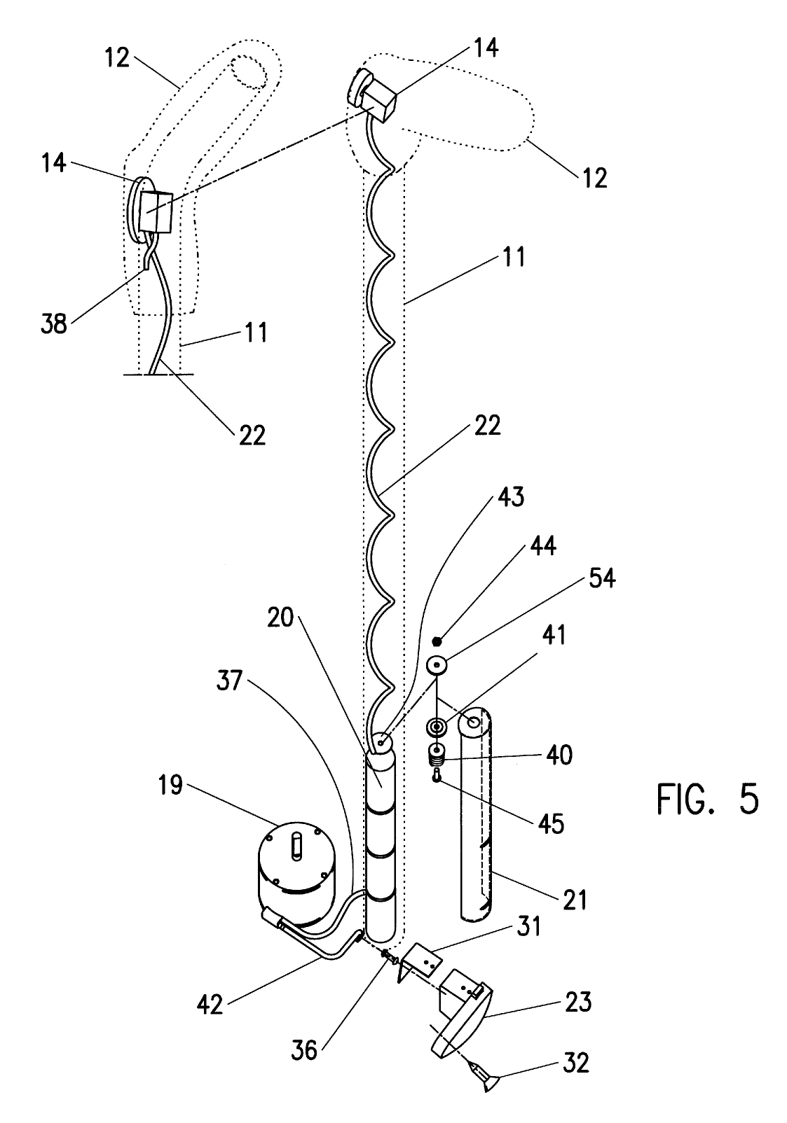

The electrical components as shown in FIG. 5 illustrated the circuitry of the sprayer 10. The upper most battery 20 conducts electricity through the battery spring 40, the battery screw 45 and the battery nut 44 to the wire disc 43 with the attached wire 22. The battery screw 45, battery spring 40, battery nut 44 and the wire disc 43 are insulated from the battery shell 21 by the insulator 41 and the upper insulator disk 54. Switch 14 is a single-throw-normally-open type switch. One contact is connected to the wire 22 and the other to the switch ground 38. Switch ground 38 is soldered to the electrically conductive handle 11. The motor 19 is connected through the power lead 42 to the contact 36. With the battery lid 23 installed, the contact strip 31 makes contact with contact 36. The contact strip 31 is fastened to the battery lid 23 and is contacting the bottom of the lowest battery 20 with its other leg, hence, establishes electrical connection of the bottom of the battery 20 with the motor 19. One side of the ground wire 37 is soldered onto the electrically conductive handle 11. When the switch 14 is depressed, the contacts inside the switch 14 are closed. This energizes the motor 19 through an electrical connection between the top of the battery 20 through the wire 22, the switch 14 and the switch ground 38 to the handle 11 and the ground wire 37. The establishing of these two electrical connections engages the motor 19.

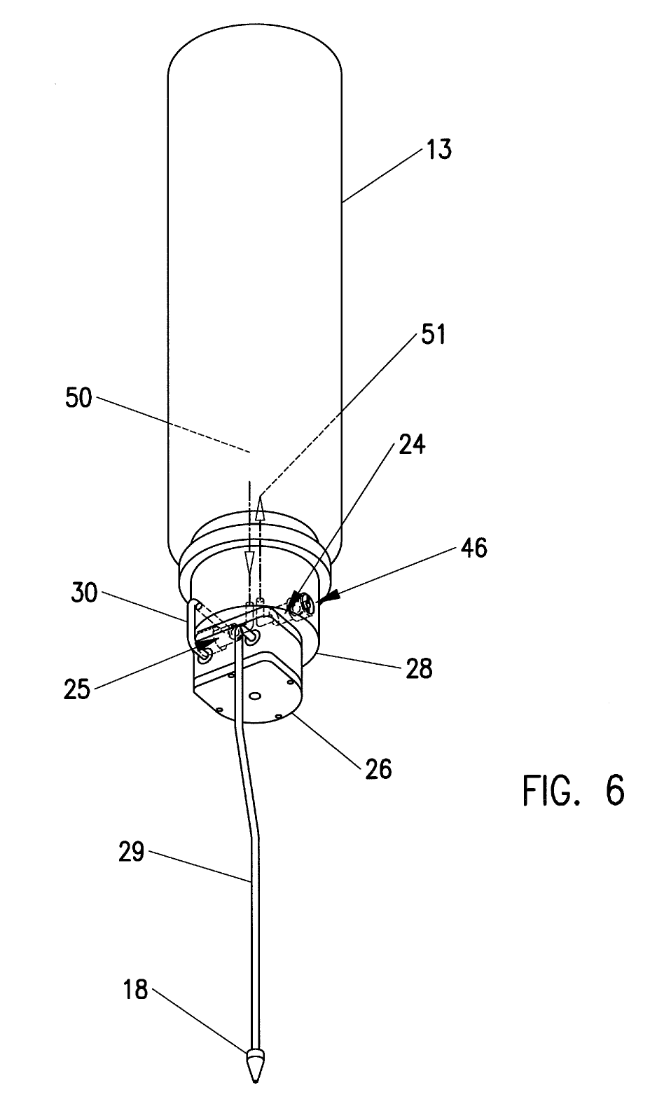

The liquid 50 is contained in the container 13, as shown in FIG. 6. The liquid passes through the container mount 28, the sealing valve 25, the connector tube 30 to the input side of the pump 26. The pump 26 pushes the liquid 50 out at the exit side, through the spray tube 29 and disperses it through the spray nozzle 18. The spent liquid 50 creates a void in the container 13, resulting in a partial vacuum. This vacuum sucks air from the outside through the air entrance 46 into the container 13. This is indicated by the arrow for the make-up air 51.

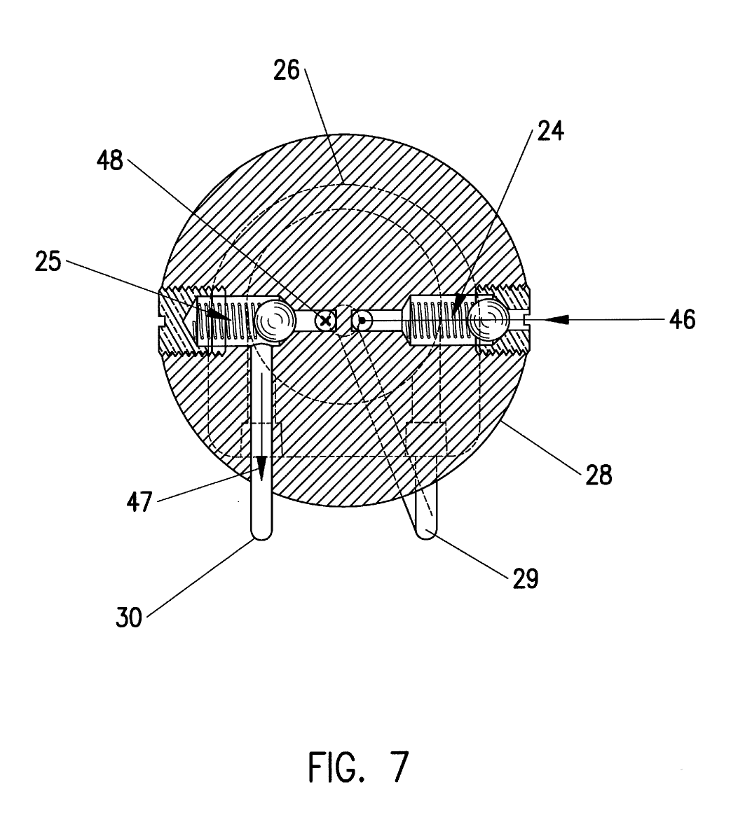

The container mount 28 is illustrated in FIG. 7. The aspirator valve 24 and sealing valve 25 are two check-valves. The aspirator valve 24 is normally closed. When liquid is sucked out of the container 13 (not shown) during the spraying action, the created vacuum opens the aspirator valve 24 to let make-up air through the air entrance 46 and the aspirator valve 24 into the container 13 (not shown). The sealing valve 25 is normally closed and prevents the leakage of liquid from the container 13 (not shown) by way of the container exit 48 through the pump 26. When the pump 26 is activated it creates a suction on its entrance side. This will open the sealing valve 25 and lets the liquid pass in the direction of the arrow 47 through the connector tube 30 to the pump 26 and out through the spray tube 29 to the spray nozzle 18 (not shown).

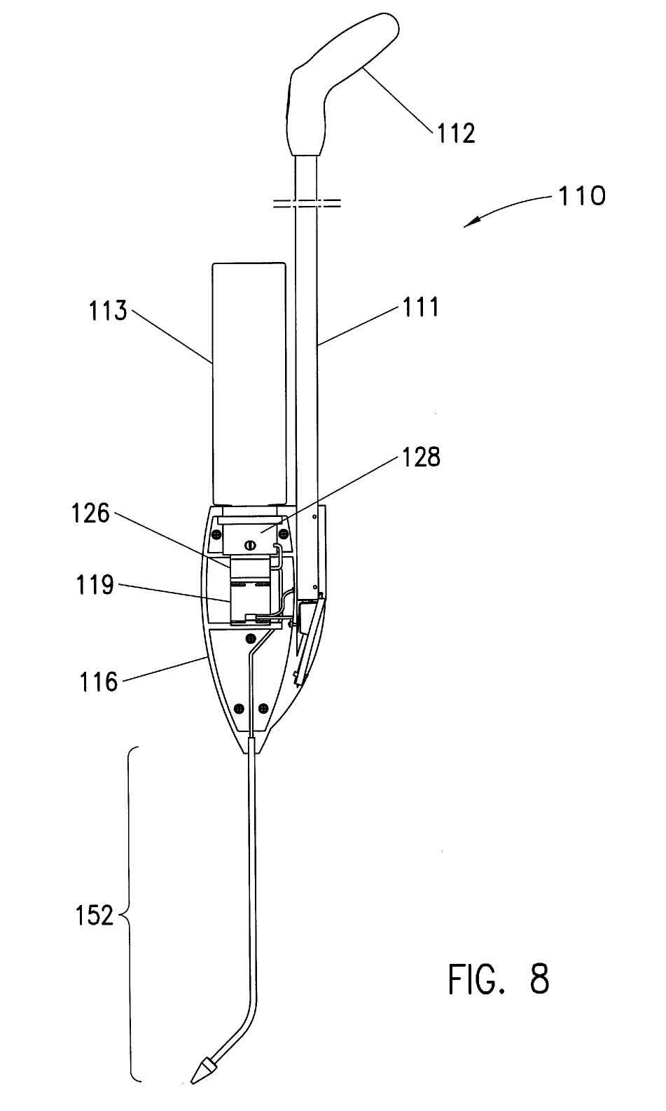

In another alternative embodiment, the sprayer 110 contains an up-bent pesticide nozzle 152 to facilitate the application of pesticide underneath the leaves. The sprayer contains all internal and external components as described above with the exception of the hood 15. The alternative embodiment does not contain a hood 15, but does include an up-bent pesticide nozzle 152. The alternative embodiment as illustrated in the cut-way of FIG. 8 further includes a handle 111, a handle grip 112, a container 113, a container mount 128, a pump 126, a motor 119.

The sprayer (10 and 110) and its component parts can be composed of any material suitable for its uses. Such material may include plastic, rubber, metal, wood, and combinations thereof.

The liquid as described herein may be any liquid the user wishes to spray on or near a plant or weed. The sprayer (10 and 110) is particularly useful when the liquid is a herbicide or pesticide.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A spraying device, comprising:
a handle;
a body having an interior void for receiving a container containing liquid;
a pump disposed within the interior void of the right shell and the left shell;
a motor disposed within the interior void of the right shell and the left shell for operating the pump; and
a spray nozzle for dispensing the liquid contained within the container.

2. The spraying device of claim 1, further comprising a switch for activating and deactivating the motor.

3. The spraying device of claim 1, further comprising a hood positioned around the spray nozzle.

4. The spraying device of claim 1, further comprising the handle having a hollow inner cavity and at least one battery positioned within the hollow inner cavity of the handle.

5. The spraying device of claim 1, further comprising a container mount having inner threads for receiving a correspondingly threaded container and engaging the container mount and the container in a releasably engaged arrangement, wherein the container mount further includes a gasket disposed between the container and container mount.

6. The spraying device of claim 1, wherein the spray nozzle is angled.

7. The spraying device of claim 1, further comprising a spray tube engaged to the pump for transporting the liquid to the spray nozzle.

8. A spraying device, comprising:
a handle having a hollow inner cavity;
a body comprising a right shell and a left shell that are releasably engaged to each other forming an interior void for receiving a container containing liquid;
a pump disposed within the interior void of the right shell and the left shell;
a motor disposed within the interior void of the right shell and the left shell for operating the pump;
a power source positioned within the hollow inner cavity of the handle for supplying power to the motor;
a switch disposed on the handle for activating and deactivating the supply of power to the motor; and
a spray nozzle for dispensing the liquid contained within the container.

9. The spraying device of claim 8, further comprising a hood positioned around the spray nozzle.

10. The spraying device of claim 8, further comprising at least one battery positioned within the hollow inner cavity of the handle.

11. The spraying device of claim 8, further comprising a container mount having inner threads for receiving a correspondingly threaded container and engaging the container mount and the container in a releasably engaged arrangement, wherein the container mount further includes a gasket disposed between the container and container mount.

12. The spraying device of claim 8, wherein the spray nozzle is angled.

13. The spraying device of claim 8, wherein the switch is engaged to an electrical wire and the electrical wire is engaged to the power source.

14. A spraying device, comprising:
a handle having a hollow inner cavity;
a body comprising a right shell and a left shell that are releasably engaged to each other forming an interior void;
a container mount disposed within the interior void for receiving a container of liquid that comprises a gasket and an aspirator valve, wherein the gasket prevents leakage from the container when engaged to the container mount and the aspirator valve permits air to pass into the container;
a pump disposed within the interior void of the right shell and the left shell;
a motor disposed within the interior void of the right shell and the left shell for operating the pump;
at least one battery positioned within the hollow inner cavity of the handle for supplying power to the motor;
a switch disposed on the handle for activating and deactivating the supply of power to the motor; and
a spray nozzle for dispensing the liquid contained within the container.

15. The spraying device of claim 14, further comprising a hood positioned around the spray nozzle.

16. The spraying device of claim 14, wherein the at least one battery is at least one rechargeable battery positioned within the hollow inner cavity of the handle.

17. The spraying device of claim 14, wherein the container mount comprises inner threads for receiving a correspondingly threaded container and engaging the container mount and the container in a releasably engaged arrangement.

18. The spraying device of claim 14, wherein the spray nozzle is angled.

19. The spraying device of claim 14, wherein the switch is engaged to an electrical wire and the electrical wire is engaged to the power source.

20. The spraying device of claim 14, further comprising a sealing valve positioned within the container mount for preventing the liquid contained in the container from leaking through the pump when the spraying device is idle.
